(19) United States
(12) Patent Application Publication
(10) Pub. No.: US 2024/0256785 A1
(43) Pub. Date: Aug. 1, 2024

(54) SYSTEM AND METHOD FOR DETERMINING A REAL-TIME RESPONSE BASED ON AN UNDERSTANDING OF THE CONVERSATIONAL CONTEXT

(71) Applicant: Walmart Apollo, LLC, Bentonville, AR (US)

(72) Inventor: Arpit Sharma, Suisun City, CA (US)

(73) Assignee: Walmart Apollo, LLC, Bentonville, AR (US)

(21) Appl. No.: 18/425,795

(22) Filed: Jan. 29, 2024

Related U.S. Application Data
(60) Provisional application No. 63/441,531, filed on Jan. 27, 2023.

(51) Int. Cl. G06F 40/35; G06F 40/284; G06Q 30/0601

(52) U.S. Cl. CPC G06F 40/35; G06F 40/284; G06Q 30/0627

(57) ABSTRACT

A method can include upon receiving, from a computer network, a conversational input from a user device for a user, determining a context based on one or more contextual units. The one or more contextual units can be associated with immediate prior one or more conversational inputs relative to the conversational input. The method further can include determining an intent associated with the conversational input based on the context. Moreover, the method can include determining one or more entities associated with the conversational input based on the context and one or more expected entities determined based on one or more predefined conversation flows. The method additionally can include determining an output based on the intent and the one or more entities. The method also can include transmitting, via the computer network, the output to be displayed on the user device. Other embodiments are disclosed.

### CROSS-REFERENCE TO RELATED APPLICATIONS

This application claims the benefit of U.S. Provisional Patent Application No. 63/441,531, filed Jan. 27, 2023. U.S. Provisional Patent Application No. 63/441,531 is incorporated herein by reference in its entirety.

### TECHNICAL FIELD

This disclosure relates generally to techniques for an improved understanding of the conversational context to simulate human conversations.

### BACKGROUND

Conventional virtual-assistant (VA) software agents are commonly used to mimic human interactions with users in various applications, such as a virtual shopping assistant, a virtual personal assistant, etc. However, these VA software agents process user queries in isolation and thus generally fail to generate relevant responses when the user queries are ambiguous. Thus, systems and methods for determining a conversational context based not only on a current conversational input but also on one or more prior conversational inputs and also for simulating a response accordingly, are desired.

### BRIEF DESCRIPTION OF THE DRAWINGS

To facilitate further description of the embodiments, the following drawings are provided in which:

FIG. 1 illustrates a front elevation view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a system for determining a context for a conversation and generating an output in response to a conversational input based at least in part on the context, according to an embodiment;

FIG. 4 illustrates a flow chart for a method of determining a context, an intent, and/or one or more entities for a conversational input, according to an embodiment; and

FIG. 5 illustrates a flow chart for a method of determining an output in response to a conversational input, according to an embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, five seconds, ten seconds, thirty seconds, one minute, five minutes, ten minutes, or fifteen minutes.

### DESCRIPTION OF EXAMPLES OF EMBODIMENTS

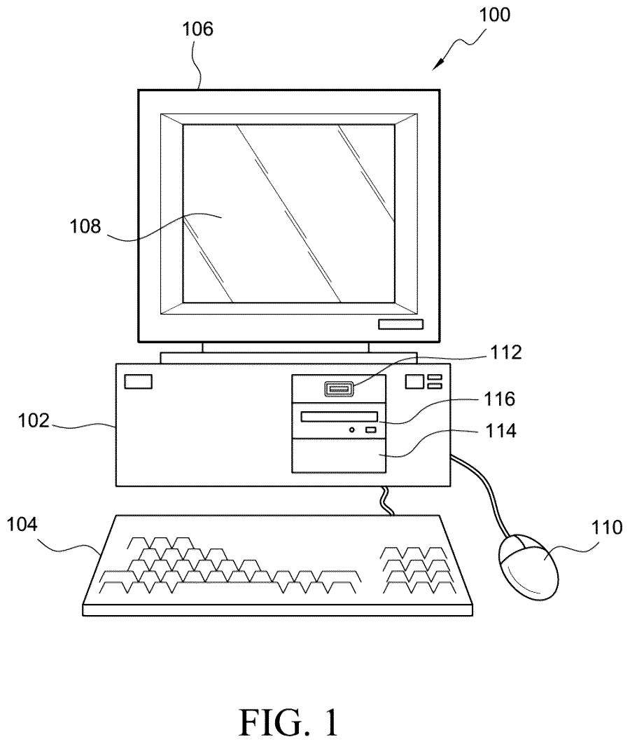

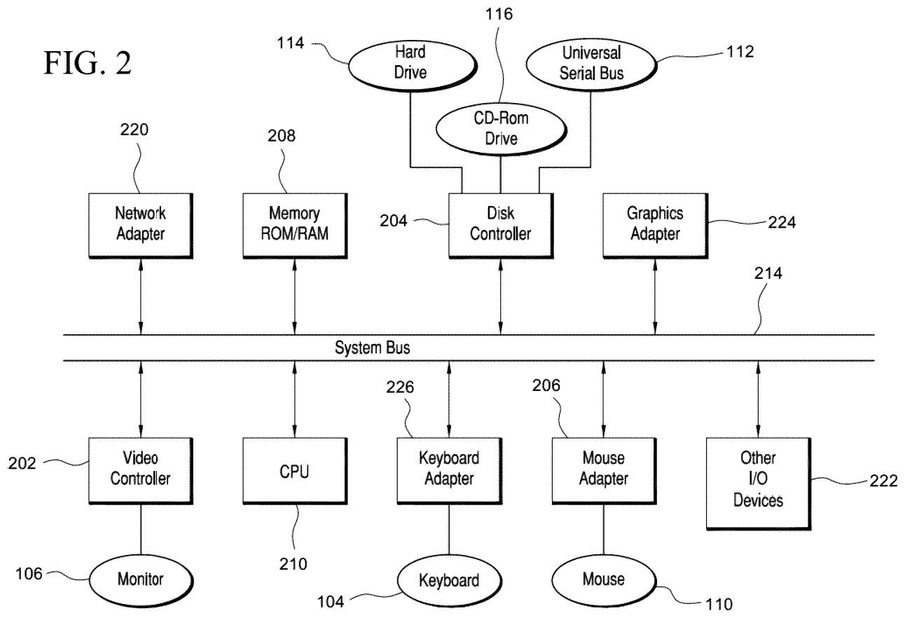

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refers to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can includes one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such Block as a smartphone. In certain additional embodiments, computer system 100 may comprise an embedded system.

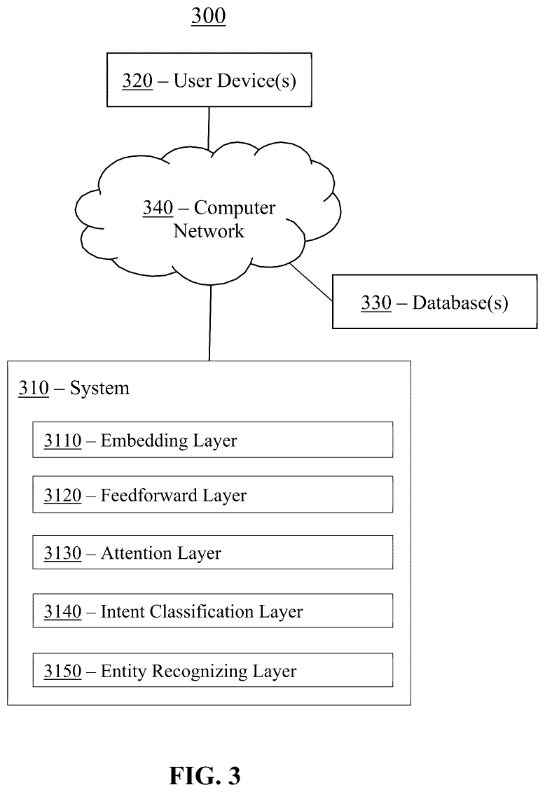

Turning ahead in the drawings, FIG. 3 illustrates a block diagram of a system 300 that can be employed for determining a context for a conversation and generating an output in response to a conversational input based at least in part on the context, according to an embodiment. In various embodiments, the conversation can be associated with interactions between a user and a virtual assistant for an online retailer. In some embodiments, the interactions can include conversational inputs from the user regarding greetings (e.g., “Hello”, “Goodbye”, etc.), general inquiries (e.g., “Can you help me buy something?”, “How to return a product?”, etc.), product search requests (e.g., “I am looking for coffee creamer”, “Christmas gifts for boys under 5”, etc.), and so forth. The conversational inputs can include text, audio, and/or video inputs.

System 300 is merely exemplary and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. System 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein. In many embodiments, operators and/or administrators of system 300 can manage system 300, the processor(s) of system 300, and/or the memory storage unit(s) of system 300 using the input device(s) and/or display device(s) of system 300, or portions thereof in each case.

In many embodiments, system 300 can include a system 310, a user device(s) 320, and/or a database(s) 330. System 310 further can include one or more elements, modules, models, or systems, such as a deep learning-based natural language understanding (NLU) module with various layers, including an embedding layer 3110, a feedforward layer 3120, an attention layer 3130, an intent classification layer 3140, and/or an entity recognizing layer 3150, etc., to perform various procedures, processes, and/or activities of system 300 and/or system 310. Each of embedding layer 3110, feedforward layer 3120, attention layer 3130, intent classification layer 3140, and/or entity recognizing layer 3150 can include one or more functions, algorithms, modules, models, and/or systems and can be pre-trained or re-trained.

System 310, user device(s) 320, embedding layer 3110, feedforward layer 3120, attention layer 3130, intent classification layer 3140, and/or entity recognizing layer 3150 can each be a computer system, such as computer system 100 (FIG. 1), as described above, and can each be a single computer, a single server, or a cluster or collection of computers or servers, or a cloud of computers or servers. In another embodiment, a single computer system can host system 310, user device(s) 320, embedding layer 3110, feedforward layer 3120, attention layer 3130, intent classification layer 3140, and/or entity recognizing layer 3150. Additional details regarding system 310, user device(s) 320, embedding layer 3110, feedforward layer 3120, attention layer 3130, intent classification layer 3140, and entity recognizing layer 3150 are described herein.

In some embodiments, system 310 can be in data communication with user device(s) 320, using a computer network (e.g., computer network 340), such as the Internet and/or an internal network that is not open to the public. Meanwhile, in many embodiments, system 310 also can be configured to communicate with and/or include a database(s) 330. In certain embodiments, database(s) 330 can include a product catalog of a retailer that contains information about products, items, or SKUs (stock keeping units), for example, among other data as described herein. In another example, database(s) 330 further can include training data (e.g., synthetic and/or historical conversational logs, tags for the synthetic and/or historical conversational logs, user feedback, etc.) and/or hyper-parameters for training and/or configuring system 310, embedding layer 3110, feedforward layer 3120, attention layer 3130, intent classification layer 3140, and/or entity recognizing layer 3150.

In a number of embodiments, database(s) 330 can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more data sources, that particular database can be stored on a single memory storage unit or the contents of that particular database can be spread across multiple ones of the memory storage units storing the one or more databases, depending on the size of the particular database and/or the storage capacity of the memory storage units. In similar or different embodiments, the one or more data sources can each be a computer system, such as computer system 100 (FIG. 1), as described above, and can each be a single computer, a single server, or a cluster or collection of computers or servers, or a cloud of computers or servers.

Database(s) 330 can include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

In many embodiments, communication between system 310, user device(s) 320, database(s) 330, embedding layer 3110, feedforward layer 3120, attention layer 3130, intent classification layer 3140, and/or entity recognizing layer 3150 can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc.

The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, system 310 can receive, from a computer network (e.g., computer network 340), a conversational input from a user device (e.g., user device(s) 320) for a user. The conversational input can be the first input form the user in a new time session of a conversation between the user and system 310 (or a front-end server (e.g., a virtual assistant) for system 310). Alternatively, the conversational can include immediate prior one or more conversational inputs, as well as responses from system 310, relative to the conversational input in an ongoing time session. The conversational input can include a complete or partial sentence. In some embodiments, the conversation between the user and system 310 can be text-based, audio-based, and/or vision-based.

For example, in embodiments where system 310 includes a virtual shopping assistant, a conversation can include the following interactions between the user and the shopping assistant of system 310:
User (input #1): hi
Assistant (response #1): hello, how can I help you
User (input #2): I want coffee creamer
Assistant (response #2): Ok, I found . . .
User (input #3): I want coffee mate

In this example, input #s 1 & 2 are immediate prior conversational inputs relative to the current conversational input (input #3).

In a number of embodiments, upon receiving the conversational input, system 310 further can determine a context based on one or more contextual units associated with the immediate prior one or more conversational inputs relative to the conversational input. The immediate prior one or more conversational inputs and the conversational input can occur in a time session of a conversation. A conversation can include multiple interactions between a user and system 310, and a time session of a conversation can include a predefined time frame (e.g., 15 minutes, 30 minutes, etc.) within which the interactions may be related. In certain embodiments, system 310 can limit the number of the immediate prior one or more conversational inputs (e.g., the 2, 3, 4, or 5 most recent prior conversational inputs) for determining the context. Once the context is determined, system 310 further can determining an intent associated with the conversational input based on the context. Additionally, system 310 can determine an entity associated with the conversational input based on the context. In the example above, input #1 includes a context conversational input, “hi”, and system 310 can determine that the context intent associated with the context conversational input of input #1 is labeled as “welcome”. System 310 also can determine that because “hi” in the context conversational input is not a meaningful or known entity for system 310, the entity associated with input #1 is an empty context entity. Input #2 can be associated with a context intent labeled as “product search” and 4 entity words, including 2 outside or ignorable entity words for “I” and “want,” a beginning entity word for “coffee,” and an ending entity word for “creamer.”

In some embodiments, system 310 can determine the entity associated with the conversational input further based on one or more expected entities. The one or more expected entities can be used to supplement a missing entity in a conversational input. For instance, in the example above, if the user enters an input #4, “Make it 2,” system 310 can determine or extract the expected entities from the immediate prior one or more conversational inputs and/or other earlier conversational inputs at the time system 310 process the prior conversational inputs and store the expected entities in a memory, cache, or database (e.g., database(s) 330). In the example above, “coffee” and “creamer” in input #1 can be the expected entities, and “coffee” and “mate” in input #2 can be the expected entities. In many embodiments, BILOU tags can be used for tagging entities. For example, the one or more expected entities can be tagged as “O”, which is an outside tag, when the immediate prior or earlier conversational inputs do not include any entities supported by system 310 (see, e.g., “hi” of input #1), or when the conversational input is the first input in the conversation. System 310 can be configured to determine the expected entities based on predefined conversation flows. In many embodiments, the predefined conversational flows can be generated manually, automatically by any suitable machine learning models, and/or in combination thereof. The predefined conversational flows further can be periodically updated based on user feedback.

In a number of embodiments, system 310 further can determine an output based on the intent and the entity. An exemplary output can be a greeting message (see, e.g., “hi” or response #1 above), an answer to an inquiry, a search result for a product search request (see, e.g., response #2), and/or an instruction to cause an item added in the shopping cart, etc. System 310 additionally can transmit, via the computer network (e.g., computer network 340), the output to be displayed on the user device (e.g., user device(s) 320).

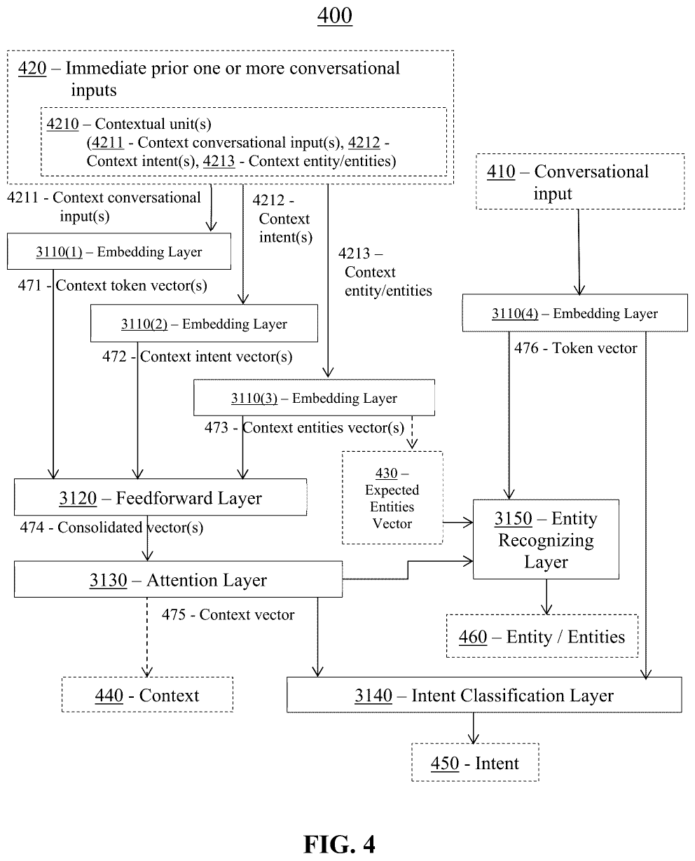

Turning ahead in the drawings, FIG. 4 illustrates a flow chart for a method 400 of determining a context, an intent, and/or one or more entities for a conversational input, according to an embodiment. Method 400 is merely exemplary and is not limited to the embodiments presented herein. Method 400 can be employed in many different embodiments or examples not specifically depicted or described herein. In some embodiments, the procedures, the processes, and/or the activities of method 400 can be performed in the order presented. In other embodiments, the procedures, the processes, and/or the activities of method 400 can be performed in any suitable order. In still other embodiments, one or more of the procedures, the processes, and/or the activities of method 400 can be combined or skipped.

In many embodiments, system 300 (FIG. 3) or system 310 (FIG. 3) (including one or more of its elements, modules, models, and/or systems, such as embedding layer 3110 (FIG. 3), feedforward layer 3120 (FIG. 3), attention layer 3130 (FIG. 3), intent classification layer 3140 (FIG. 3), and/or entity recognizing layer 3150 (FIG. 3)) can be suitable to perform method 400 and/or one or more of the activities of method 400. In these or other embodiments, one or more of the activities of method 400 can be implemented as one or more computing instructions configured to run at one or more processors and configured to be stored at one or more non-transitory computer readable media. Such non-transitory computer readable media can be part of a computer system such as system 300 (FIG. 3) or system 310 (FIG. 3). The processor(s) can be similar or identical to the processor(s) described above with respect to computer system 100 (FIG. 1).

Referring to FIG. 4, method 400 can determine a context (e.g., a context 440) based on one or more contextual units (e.g., contextual unit(s) 4210). In a number of embodiments, contextual unit(s) 4210 can be associated with immediate prior one or more conversational inputs (e.g., immediate prior one or more conversational inputs 420) relative to a conversational input (e.g., conventional input 410) received, via a computer network (e.g., computer network 340 (FIG. 3)), from a user device (e.g., user device(s) 320 (FIG. 3)) for a user. In many embodiments, contextual unit(s) 4210 for determining context 440 can include: (a) a respective context conversational input (e.g., context conversational input(s) 4211) for each of immediate prior one or more conversational inputs 420; (b) a respective context intent vector (e.g., context intent vector(s) 472) for a respective context intent (e.g., content intent(s) 4212) associated with context conversational input(s) 4211; and (c) a respective context entities vector (e.g., context entities vector(s) 473) for one or more respective context entities (e.g., context entity/entities 4213) associated with context conversational input(s) 4211.

In some embodiments, the respective context conversational input (e.g., context conversational input(s) 4211) can be a textual input the user provides (or an audio/video input converted to the textual input) before the conversational input (e.g., conversational input 410). In the example above, the respective context conversational input for each of the immediate prior one or more conversational inputs (e.g., input #1 and input #2) can include “hi” or “I want coffee creamer”. The respective context intent (e.g., context intent(s) 4212) and the one or more respective context entities (e.g., context entity/entities 4213) can be determined from the respective context conversational input (e.g., “hi”, “I want coffee creamer”, or context conversational input(s) 4211) based on predefined intents and entities known to system 310. When system 310 of an embodiment includes a virtual shopping assistant, exemplary known intents can include “welcome” or “greeting,” “inquiry,” “product search,” “edit product attribute” or “refine product search,” “add to cart,” and so on, and exemplary known entities can include generic product names, brands, and/or product attributes, etc.

Furthermore, in many embodiments, the respective context intent vector (e.g., context intent vector 472) for the respective context intent (e.g., context intent(s) 4212) associated with the respective context conversational input (e.g., context conversational input(s) 4211) can be encoded, by any suitable encoder (e.g., embedding layer 3110, one-hot encoder, etc.), based on the respective context intent and predefined intent vector values (e.g., 2⁰ for “welcome,” 2¹ for “product search,” 2² for “edit product attributes,” etc.). The respective context entities vector for one or more respective context entities associated with the respective context conversational input can be encoded, by any suitable encoder (e.g., embedding layer 3110, one-hot encoder, etc.), based on the one or more respective context entities and predefined entity tags (e.g., “B”, “I”, “L”, “O”, or “U”, etc. in BILOU tagging).

Still referring to FIG. 4, in some embodiments, determining the context (e.g., context 440) in method 400 can include: (a) generating, by an embedding layer (e.g., embedding layer 3110(1)), a respective context token vector (e.g., context token vector(s) 471) for each of the one or more contextual units (e.g., contextual unit(s) 4210) based on the respective context conversational input (e.g., context conversational input(s) 4211) of the each of contextual unit(s) 4210; (b) generating, by a feedforward layer (e.g., feedforward layer 3120), a respective consolidated vector (e.g., consolidated vector(s) 474) for each of contextual unit(s) 4210 based on (i) context token vector(s) 471, (ii) the respective context intent vector (e.g., context intent vector(s) 472), and (iii) the respective context entities vector (e.g., context entities vector(s) 473) for the each of contextual unit(s) 4210; and (c) concatenating, by an attention layer (e.g., attention layer 3130), consolidated vector(s) 474 for each of contextual unit(s) 4210 into a single multi-dimensional context vector (e.g., context vector 475).

In many embodiments, the embedding layer (e.g., embedding layer 3110(1)) for generating a respective context token vector (e.g., context token vector(s) 471) based on the respective context conversational input (e.g., context conversational input(s) 4211, “hi” for input #1, or “I want coffee creamer” for input #2) can include any suitable one or more functions, algorithms, modules, models, and/or systems, such as a pre-trained BERT model. Context token vector(s) 471 generated by embedding layer 3110(1) can include CLS tokens for the one or more contextual units (e.g., contextual unit(s) 4210) associated with immediate prior one or more conversational inputs 420 (e.g., input #s 1 & 2). The feedforward layer (e.g., feedforward layer 3120) can consolidate (i) context token vector(s) 471, (ii) context intent vector(s) 472, and (iii) context entities vector(s) 473 for each of contextual unit(s) 4210 to create consolidated vector(s) 474 for each of contextual unit(s) 4210 by any suitable functions, algorithms, modules, models, and/or systems, such as a fully connected feedforward neural network (FNN), a convolutional neural network (CNN), etc. The attention layer (e.g., attention layer 3130) further can consolidate consolidated vector(s) 474 that is or are generated by feedforward layer 3120 for each of contextual unit(s) 4210 associated with immediate prior one or more conversational inputs 420 to create a single multi-dimensional context vector (e.g., context vector 475) with suitable weights for consolidated vector(s) 474, by any suitable functions, algorithms, modules, models, and/or systems, such as a self-attention model, a hierarchical-input model, etc.

In various embodiments, the respective context token vector (e.g., context token vector(s) 471), the respective consolidated vector (e.g., consolidated vector(s) 474), the respective context intent vector (e.g., context intent vector(s) 472), the respective context entities vector (e.g., context entities vector(s) 473), and/or the single multi-dimensional context vector (e.g., context vector 475) each can be of any suitable dimensions. For instance, the respective consolidated vector (e.g., consolidated vector(s) 474), determined by a fully connected FNN (e.g., feedforward layer 3120), can have an exemplary dimension of 700. The respective context intent vector (e.g., context intent vector(s) 472), determined by a one-hot encoder (e.g., embedding layer 3110(2)), can have a dimension of N (the number of predefined intent values), which can be 57. The respective context entities vector (e.g., context entities vector(s) 473), determined by a one-hot encoder (e.g., embedding layer 3110(3)), can have a dimension of M (the number of predefined entity tags), which can be 32. In some embodiments, embedding layer 3110(1), embedding layer 3110(2), and/or embedding layer 3110(3) can include one or more similar or different one or more functions, algorithms, modules, models, and/or systems.

Still referring to FIG. 4, in a number of embodiments, method 400 further can include determining an intent (e.g., intent 450) associated with the conversational input (e.g., conversational input 410) based on the context (e.g., context 440). Method 400 can determine intent 450 by: (a) generating, by an embedding layer (e.g., embedding layer 3110(4)), a token vector (e.g., token vector 476) for the conversational input (e.g., conversational input 410); and (b) determining, by an intent classification layer (e.g., intent classification layer 3140), intent 450 based on token vector 476 and a single multi-dimensional context vector (e.g., context vector 475) for context 440. Embedding layer 3110(4) for generating token vector 476, and intent classification layer 3140 for determining intent 450 each can include any suitable functions, algorithms, modules, models, and/or systems.

For instance, embedding layer 3110(4) can include a pre-trained BERT model, or any layer that is similar or different from embedding layer 3110(1), embedding layer 3110(2), and/or embedding layer 3110(3). Further, token vector 476 for conversational input 410 can include one or more tokens (e.g., CLS token embeddings generated by a BERT model) for the representation of conventional input 410. An exemplary intent classification layer (e.g., intent classification layer 3140) can include any suitable functions, algorithms, modules, models, and/or systems, such as a combination of a feedforward layer (e.g., a fully connected FNN) for determining one or more intent candidates (among the predefined intents) and a softmax layer (e.g., a softmax function) to determine intent 450 based on the respective probability for each of the one or more intent candidates. The exemplary feedforward layer of the intent classification layer 3140 can be similar to or different from feedforward layer 3120.

In a number of embodiments, the single multi-dimensional context vector (e.g., context vector 475) for the context (e.g., context 440) can be determined by: (a) generating a respective context token vector (e.g., context token vector(s) 471) for each of the one or more contextual units (e.g., contextual unit(s) 4210, input #1, or input #2); (b) generating a respective consolidated vector (e.g., consolidated vector(s) 474) for each of the one or more contextual units (e.g., contextual unit(s) 4210); and (c) concatenating consolidated vector(s) 474 for each of contextual unit(s) 4210 into context vector 475.

In some embodiments, the respective context token vector (e.g., context token vector(s) 471) for each of the one or more contextual units (e.g., contextual unit(s) 4210) can be generated by an embedding layer (e.g., embedding layer 3110(1)) based on a respective context conversational input (e.g., context conversational input(s) 4211, “hi” of input #1, or “I want coffee creamer” of input #2) of each of the one or more contextual units (e.g., contextual unit(s) 4210). The respective consolidated vector (e.g., consolidated vector(s) 474) for each of the one or more contextual units (e.g., contextual unit(s) 4210) can be generated by a feedforward layer (e.g., feedforward layer 3120) based on: (a) the respective context token vector (e.g., context token vector(s) 471) for the each of the one or more contextual units (e.g., contextual unit(s) 4210), (b) a respective context intent vector (e.g., context intent vector(s) 472) for a respective context intent (e.g., context intent(s) 4212) associated with the respective context conversational input (e.g., context conversational input(s) 4211) of the each of the one or more contextual units (e.g., contextual unit(s) 4210), and (c) a respective context entities vector (e.g., context entities vector(s) 473) for one or more respective context entities (e.g., context entity/entities 4213) associated with context conversational input(s) 4211 of contextual unit(s) 4210. The respective context entities vector (e.g., consolidated vector(s) 474) for the one or more contextual units (e.g., contextual unit(s) 4210) can be concatenated by an attention layer (e.g., attention layer 3130) into the single multi-dimensional context vector (e.g., context vector 475).

Referring to FIG. 4, in many embodiments, method 400 additionally can determine one or more entities (e.g., entity/entities 460) associated with the conversational input (e.g., conversational input 410). Determining entity/entities 460 in method 400 can include generating, by an embedding layer (e.g., embedding layer 3110(4)), a token vector (e.g., token vector 476) for conversational input 410. Embedding layer 3110(4) can be similar to or different from embedding layer 3110(1), 3110(2), or 3110(3), and can include any suitable functions, algorithms, modules, models, and/or systems, such as a pre-trained BERT module. Token vector 476 for conversational input 410 can include one or more tokens (e.g., CLS tokens). Determining entity/entities 460 further can include concatenating (a) the token vector (e.g., token vector 476), as generated, (b) a single multi-dimensional context vector (e.g., context vector 475) for the context (e.g., context 440), and (c) an expected entities vector (e.g., expected entities vector 430) for the one or more expected entities into a consolidated entity vector. In some embodiments, the consolidated entity vector can include a predefined format (e.g., in a sequence of the token vector, the context, and the expected entities vector) and/or a predefined dimension (e.g., 32).

In some embodiments, determining entity/entities 460 in method 400 also can include determining, by an entity recognizing layer (e.g., entity recognizing layer 3150), a respective entity tag (e.g., “B”, “I”, or “L”) for each of the one or more entities (e.g., entity/entities 460) based on the consolidated entity vector. Entity recognizing layer 3150 can comprise any suitable functions, algorithms, modules, models, and/or systems, such as a combination of a feedforward layer (e.g., a fully connected FNN) for determining one or more respective candidate entity tags among the predefined entity tags (e.g., BILOU tags) for each of entity/entities 460 and a softmax layer (e.g., a softmax function) for determining the respective entity tag for each of entity/entities 460 based on the respective probability for each of the candidate entity tags. The exemplary feedforward layer of entity recognizing layer 3150 can be similar to or different from feedforward layer 3120.

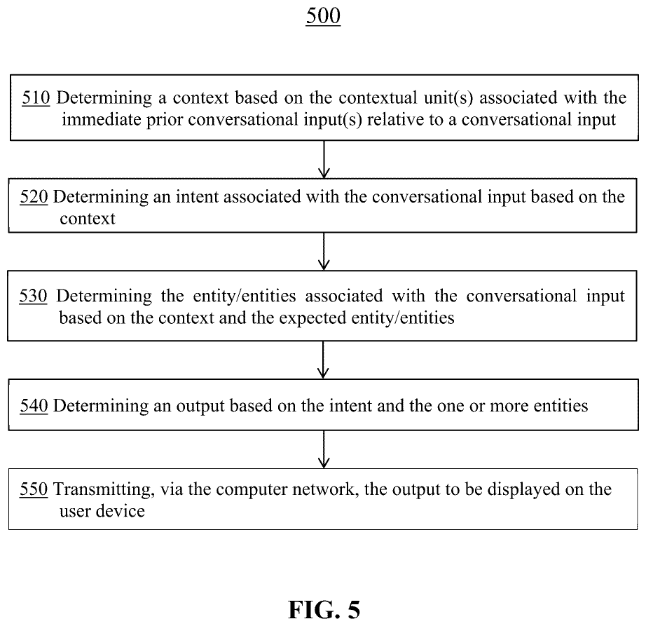

Turning ahead in the drawings, FIG. 5 illustrates a flow chart for a method 500 of determining an output in response to a conversational input, according to an embodiment. Method 500 is merely exemplary and is not limited to the embodiments presented herein. Method 500 can be employed in many different embodiments or examples not specifically depicted or described herein. In some embodiments, the procedures, the processes, and/or the activities of method 500 can be performed in the order presented. In other embodiments, the procedures, the processes, and/or the activities of method 500 can be performed in any suitable order. In still other embodiments, one or more of the procedures, the processes, and/or the activities of method 500 can be combined or skipped.

In many embodiments, system 300 (FIG. 3) or system 310 (FIG. 3) (including one or more of its elements, modules, models, and/or systems, such as embedding layer 3110 (FIG. 3), embedding layer 3110(1) (FIG. 4), embedding layer 3110(2) (FIG. 4), embedding layer 3110(3) (FIG. 4), embedding layer 3110(4) (FIG. 4), feedforward layer 3120 (FIG. 3), attention layer 3130 (FIG. 3), intent classification layer 3140 (FIG. 3), entity recognizing layer 3150 (FIG. 3)) can be suitable to perform method 500 and/or one or more of the activities of method 500. In these or other embodiments, one or more of the activities of method 500 can be implemented as one or more computing instructions configured to run at one or more processors and configured to be stored at one or more non-transitory computer readable media. Such non-transitory computer readable media can be part of a computer system such as system 300 (FIG. 3) or system 310 (FIG. 3). The processor(s) can be similar or identical to the processor(s) described above with respect to computer system 100 (FIG. 1). Furthermore, in a number of embodiments, method 500 can include one or more procedures, processes, or activities in method 400.

In a number of embodiments, method 500 can include a block 510 of determining a context (e.g., context 440 (FIG. 4)) based on one or more contextual units (e.g., contextual unit(s) 4210 (FIG. 4)) associated with one or more immediate prior conversational inputs (e.g., immediate prior conversational inputs 420 (FIG. 4)) relative to a conversational input (e.g., conversational input 410 (FIG. 4)). Block 510 further can include generating, by an embedding layer (e.g., embedding 3110 (FIG. 3) or embedding 3110(1) (FIG. 4)), a respective context token vector (e.g., context token vector(s) 471 (FIG. 4)) for each of the one or more contextual units (e.g., contextual unit(s) 4210 (FIG. 4)) based on the respective context conversational input (e.g., context conversational input(s) 4211 (FIG. 4)) of the each of the one or more contextual units (e.g., contextual unit(s) 4210 (FIG. 4)).

In some embodiments, block 510 further can include generating, by a feedforward layer (e.g., feedforward layer 3120 (FIGS. 3-4)), a respective consolidated vector (e.g., consolidated vector(s) 474 (FIG. 4)) for each of the one or more contextual units (e.g., contextual unit(s) 4210 (FIG. 4)) based on the respective context token vector (e.g., context token vector(s) 471 (FIG. 4)), the respective context intent vector (e.g., context intent vector(s) 472 (FIG. 4)), and the respective context entities vector (e.g., context entities vector(s) 473 (FIG. 4)) for the each of the one or more contextual units (e.g., contextual unit(s) 4210 (FIG. 4)). In addition, block 500 can include concatenating, by an attention layer (e.g., attention layer 3130 (FIGS. 3-4)), the respective consolidated vector (e.g., consolidated vector(s) 474 (FIG. 4)) for each of the one or more contextual units (e.g., contextual unit(s) 4210 (FIG. 4)) into a single multi-dimensional context vector (e.g., context vector 475 (FIG. 4)).

In many embodiments, method 500 further can include a block 520 of determining an intent (e.g., intent 450 (FIG. 4)) associated with the conversational input (e.g., conversational input 410 (FIG. 4)) based on the context (e.g., context 440 (FIG. 4)), as determined in block 510. Block 520 further can include generating, by an embedding layer (e.g., embedding layer 3110 (FIG. 3) or embedding 3110(4) (FIG. 4)), a token vector (e.g., token vector 476 (FIG. 4)) for the conversational input (e.g., conversational input 410 (FIG. 4)). In certain embodiments, block 520 also can include determining, by an intent classification layer (e.g., intent classification layer 3140 (FIGS. 3-4)), the intent (e.g., intent 450 (FIG. 4)) based on the token vector (e.g., token vector 476 (FIG. 4)) and a single multi-dimensional context vector (e.g., context vector 475 (FIG. 4)) for the context (e.g., context 440 (FIG. 4)).

Still referring to FIG. 5, in a number of embodiments, method 500 also can include a block of 530 of determining one or more entities (e.g., entity/entities 460 (FIG. 4)) associated with the conversational input (e.g., conversational input 410 (FIG. 4)) based on the context (e.g., context 440 (FIG. 4)), as determined in block 510, and one or more expected entities. Block 530 further can include generating, by an embedding layer (e.g., embedding 3110 (FIG. 3) or embedding 3110(4) (FIG. 4)), a token vector (e.g., token vector 476 (FIG. 4)) for the conversational input (e.g., conversational input 410 (FIG. 4)). Block 530 additionally can include concatenating the token vector (e.g., token vector 476 (FIG. 4)), a single multi-dimensional context vector (e.g., context vector 475 (FIG. 4)) for the context (e.g., context 440 (FIG. 4)), and an expected entities vector (e.g., expected entities vector 430 (FIG. 4)) for the one or more expected entities into a consolidated entity vector. In some embodiments, block 530 further can include determining, by an entity recognizing layer (e.g., entity recognizing layer 3150 (FIGS. 3-4)), a respective entity tag for each of the one or more entities (e.g., entity/entities 460 (FIG. 4)) based on the consolidated entity vector.

In many embodiments, method 500 further can include a block 540 of determining an output based on the intent (e.g., intent 450 (FIG. 4)) and the one or more entities (e.g., entity/entities 460 (FIG. 4)), as determined in blocks 520 and 530 respectively. For example, the output can be a greeting, an answer to an inquiry, a search result for a product search query, etc. Moreover, method 500 also can include a block 550 of transmitting, via the computer network (e.g., computer network 340 (FIG. 3)), the output to be displayed on the user device (e.g., user device 320 (FIG. 3)). For example, for a virtual assistant, block 550 can transmit the output (e.g., a reply or an answer) to be shown or spoken on the user device.

Various embodiments can include a system for determining a conversational context for a conversational input. The system can include one or more processors and one or more non-transitory computer-readable media storing computing instructions configured to, when run on the one or more processors, cause the one or more processors to perform various acts. The acts can include upon receiving, from a computer network, a conversational input from a user device for a user, determining a context based on one or more contextual units, wherein the one or more contextual units are associated with immediate prior one or more conversational inputs relative to the conversational input. The acts further can include determining an intent associated with the conversational input based on the context. The acts additionally can include determining one or more entities associated with the conversational input based on the context and one or more expected entities. Moreover, the acts can include determining an output based on the intent and the one or more entities. The acts further can include transmitting, via the computer network, the output to be displayed on the user device.

Various embodiments further can include a method being implemented via execution of computing instructions configured to run at one or more processors and stored at one or more non-transitory computer-readable media. The method can include upon receiving, from a computer network, a conversational input from a user device for a user, determining a context based on one or more contextual units, wherein the one or more contextual units are associated with immediate prior one or more conversational inputs relative to the conversational input. The method further can include determining an intent associated with the conversational input based on the context. In addition, the method can include determining one or more entities associated with the conversational input based on the context and one or more expected entities. Furthermore, the method can include determining an output based on the intent and the one or more entities. Finally, the method can include transmitting, via the computer network, the output to be displayed on the user device.

Various embodiments additionally can include a system for determining a conversational context for a conversational input and generating a response accordingly. The system can include one or more processors and one or more non-transitory computer-readable media storing computing instructions configured to, when run on the one or more processors, cause the one or more processors to perform one or more acts. The one or more acts can include upon receiving, from a computer network, a conversational input from a user device for a user, determining a context based on one or more contextual units. The one or more contextual units can be associated with immediate prior one or more conversational inputs relative to the conversational input. The one or more acts further can include determining an intent associated with the conversational input based on the context. The one or more acts also can include determining one or more entities associated with the conversational input based on the context and one or more expected entities determined based on one or more predefined conversation flows. After the intent and the one or more entities are determined, the one or more acts can include determining an output based on the intent and the one or more entities. Finally, the one or more acts can include transmitting, via the computer network, the output to be displayed on the user device.

Various embodiments also can include a method for determining a conversational context for a conversational input and generating a response accordingly. The method can be implemented via execution of computing instructions configured to run at one or more processors and stored at one or more non-transitory computer-readable media. The method can include upon receiving, from a computer network, a conversational input from a user device for a user, determining a context based on one or more contextual units. The one or more contextual units can be associated with immediate prior one or more conversational inputs relative to the conversational input. The method also can include determining an intent associated with the conversational input based on the context. Moreover, the method can include determining one or more entities associated with the conversational input based on the context and one or more expected entities determined based on one or more predefined conversation flows. Additionally, the method can include determining an output based on the intent and the one or more entities. The method further can include transmitting, via the computer network, the output to be displayed on the user device.

In many embodiments, the techniques described herein can provide a practical application and several technological improvements. In some embodiments, the techniques described herein can provide improved natural language understanding (NLU) of a computer system (e.g., a virtual assistant) based on conversational context learned from prior interactions with users. These techniques described herein can provide a significant improvement over conventional NLU approaches. Some conventional approaches rely on a user's latest conversational input and thus cannot fully understand the user's intent or the entities involved when the latest conversational input is ambiguous. Other approaches use dialog state tracking with deterministic rules. However, deterministic rules generally are difficult to manage and often subject to exceptions. As such, an improved NLU system or method with a novel deep learning architecture as disclosed here is desired.

In a number of embodiments, the techniques described herein can solve a technical problem that arises only within the realm of computer environment, as virtual assistants do not exist outside the realm of computer networks. Moreover, the techniques described herein can solve a technical problem that cannot be solved outside the context of computer networks. Specifically, the techniques described herein cannot be used outside the context of computer networks, in view of a lack of data.

Although automatic natural language understanding has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-5 may be modified, and that the foregoing discussion of certain of these embodiments does not necessarily represent a complete description of all possible embodiments. For example, one or more of the procedures, processes, or activities of FIGS. 4-5 may include different procedures, processes, and/or activities and be performed by many different models or layers, in many different orders. As another example, the modules, models, elements, layers, and/or systems within system 300 or system 310 in FIG. 3 or used in method 400 in FIG. 4 can be interchanged or otherwise modified. Further, the systems and/or methods can include training the deep-learning architecture and/or various layers in system 300 or 310 in FIG. 3 based on training datasets as well as preparing the training datasets by using historical user logs that are tagged and validated. Moreover, the systems and/or methods can include optimizing the deep-learning architecture and/or various layers in system 300 or 310 in FIG. 3 by adjusting the hyper-parameters used.

Further, in many embodiments, one or more machine learning models (e.g., embedding layer 3110 (FIG. 3), feedforward layer 3120 (FIG. 3), attention layer 3130 (FIG. 3), intent classification layer 3140 (FIG. 3), and/or entity recognizing layer 3150 (FIG. 3), etc.) can be pre-trained or trained to perform one or more of the above-mentioned procedures, processes, activities, and/or methods in system 300 (FIG. 3), system 310 (FIG. 3), method 400 (FIG. 4), and/or method 500 (FIG. 5). Examples of the algorithms used for the machine learning models can include BERT, LLM, Lambda, Palm, XLNet, GPT-3, GPT-4, K-Nearest Neighbors (KNNs), decision trees, linear regression, logistic regression, K-Means, neural networks, fuzzy logic, fully connected feedforward neural network (FNN), convolutional neural networks (CNNs), and so forth.

Additionally, in various embodiments, each of the machine learning models used can be trained once or dynamically and/or regularly (e.g., every day, every week, etc.). The training of each of the machine learning models can be supervised, semi-supervised, and/or unsupervised. The training data of training datasets for pre-training or re-training each of the machine learning models can be collected from various data sources, including synthetic training data, or historical input and/or output data by the machine learning model, etc. For example, in a number of embodiments, the input and/or output data of a machine learning model can be curated by a user (e.g., a machine learning engineer, etc.) or automatically collected every time the machine learning model generates new output data to update the training datasets for re-training the machine learning model. In many embodiments, the trained and/or re-trained machine learning model as well as the training datasets can be stored in, updated, and accessed from a database (e.g., database(s) 330 (FIG. 3)).

In some embodiments, the users, systems, and/or methods further can determine whether to add the newly-created historical input and/or output data to the training dataset for retraining the machine learning model(s) based on user feedback, predetermined criteria, and/or confidence scores for the historical output data. The user feedback can be associated with the output data of the machine learning model(s) or the output of the systems and/or methods using the machine learning model(s) (e.g., system 300 (FIG. 3), system 310 (FIG. 3), method 400 (FIG. 4), method 500 (FIG. 5), etc.). Examples of user feedback can include a review score, one or more user actions (e.g., a user's decision to add an item to the online shopping cart, etc.), and so forth.

In embodiments where machine learning techniques are not explicitly described in the processes, procedures, activities, and/or methods, such processes, procedures, activities, and/or methods can be read to include machine learning techniques suitable to perform the intended activities (e.g., determining, processing, analyzing, generating, etc.). In a number of embodiments, the one or more machine learning models can be configured to start or stop automatically upon occurrence of predefined events and/or conditions. In certain embodiments, the systems and/or methods can use a pre-trained machine learning model, without any re-training.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processors; and
one or more non-transitory computer-readable media storing computing instructions configured to, when run on the one or more processors, cause the one or more processors to perform:
upon receiving, from a computer network, a conversational input from a user device for a user, determining a context based on one or more contextual units, wherein the one or more contextual units are associated with immediate prior one or more conversational inputs relative to the conversational input;
determining an intent associated with the conversational input based on the context;
determining one or more entities associated with the conversational input based on the context and one or more expected entities determined based on one or more predefined conversation flows;
determining an output based on the intent and the one or more entities; and
transmitting, via the computer network, the output to be displayed on the user device.

2. The system in claim 1, wherein:
each of the one or more contextual units comprises:
a respective context conversational input for each of the immediate prior one or more conversational inputs;
a respective context intent vector for a respective context intent associated with the respective context conversational input; and
a respective context entities vector for one or more respective context entities associated with the respective context conversational input.

3. The system in claim 2, wherein:
the respective context intent vector is encoded based on the respective context intent and predefined intent vector values; and
the respective context entities vector is encoded based on the one or more respective context entities and predefined entity tags.

4. The system in claim 2, wherein:
determining the context further comprises:
generating, by an embedding layer, a respective context token vector for each of the one or more contextual units based on the respective context conversational input of the each of the one or more contextual units;
generating, by a feedforward layer, a respective consolidated vector for each of the one or more contextual units based on the respective context token vector, the respective context intent vector, and the respective context entities vector for the each of the one or more contextual units; and
concatenating, by an attention layer, the respective consolidated vector for each of the one or more contextual units into a single multi-dimensional context vector.

5. The system in claim 4, wherein one or more of:
the embedding layer comprises a pre-trained BERT model; or
the respective context token vector for each of the one or more contextual units further comprises one or more CLS tokens.

6. The system in claim 1, wherein:
determining the intent associated with the conversational input based on the context further comprises:
generating, by an embedding layer, a token vector for the conversational input; and
determining, by an intent classification layer, the intent based on the token vector and a single multi-dimensional context vector for the context.

7. The system in claim 6, wherein one or more of:
the embedding layer comprises a pre-trained BERT model;
the token vector for the conversational input further comprises one or more CLS tokens;
the intent classification layer comprises a first feedforward layer and a softmax layer; or
the single multi-dimensional context vector for the context is determined by:
generating, by the embedding layer, a respective context token vector for each of the one or more contextual units based on a respective context conversational input of the each of the one or more contextual units;
generating, by a second feedforward layer, a respective consolidated vector for each of the one or more contextual units based on: (a) the respective context token vector for the each of the one or more contextual units, (b) a respective context intent vector for a respective context intent associated with the respective context conversational input of the each of the one or more contextual units, and (c) a respective context entities vector for one or more respective context entities associated with the respective context conversational input of the each of the one or more contextual units; and
concatenating, by an attention layer, the respective consolidated vector for each of the one or more contextual units into the single multi-dimensional context vector.

8. The system in claim 1, wherein:
determining the one or more entities associated with the conversational input further comprises:
generating, by an embedding layer, a token vector for the conversational input;
concatenating the token vector, a single multi-dimensional context vector for the context, and an expected entities vector for the one or more expected entities into a consolidated entity vector; and
determining, by an entity recognizing layer, a respective entity tag for each of the one or more entities based on the consolidated entity vector.

9. The system in claim 8, wherein one or more of:
the single multi-dimensional context vector for the context is determined by:
generating, by the embedding layer, a respective context token vector for each of the one or more contextual units based on a respective context conversational input of the each of the one or more contextual units;
generating, by a third feedforward layer, a respective consolidated vector for each of the one or more contextual units based on: (a) the respective context token vector for the each of the one or more contextual units, (b) a respective context intent vector for a respective context intent associated with the respective context conversational input of the each of the one or more contextual units, and (c) a respective context entities vector for one or more respective context entities associated with the respective context conversational input of the each of the one or more contextual units; and
concatenating, by an attention layer, the respective consolidated vector for each of the one or more contextual units into the single multi-dimensional context vector;
the expected entities vector is encoded based on the one or more expected entities and predefined entity tags;
the embedding layer comprises a pre-trained BERT model;
the token vector for the conversational input further comprises one or more CLS tokens; or
the entity recognizing layer comprises a fourth feedforward layer and a softmax layer.

10. The system in claim 1, wherein:
the immediate prior one or more conversational inputs and the conversational input occur in a time session of a conversation.

11. A method being implemented via execution of computing instructions configured to run at one or more processors and stored at one or more non-transitory computer-readable media, the method comprising:
upon receiving, from a computer network, a conversational input from a user device for a user, determining a context based on one or more contextual units, wherein the one or more contextual units are associated with immediate prior one or more conversational inputs relative to the conversational input;
determining an intent associated with the conversational input based on the context;
determining one or more entities associated with the conversational input based on the context and one or more expected entities determined based on one or more predefined conversation flows;
determining an output based on the intent and the one or more entities; and
transmitting, via the computer network, the output to be displayed on the user device.

12. The method in claim 11, wherein:
each of the one or more contextual units comprises:
a respective context conversational input for each of the immediate prior one or more conversational inputs;
a respective context intent vector for a respective context intent associated with the respective context conversational input; and
a respective context entities vector for one or more respective context entities associated with the respective context conversational input.

13. The method in claim 12, wherein:
the respective context intent vector is encoded based on the respective context intent and predefined intent vector values; and
the respective context entities vector is encoded based on the one or more respective context entities and predefined entity tags.

14. The method in claim 12, wherein:
determining the context further comprises:
generating, by an embedding layer, a respective context token vector for each of the one or more contextual units based on the respective context conversational input of the each of the one or more contextual units;
generating, by a feedforward layer, a respective consolidated vector for each of the one or more contextual units based on the respective context token vector, the respective context intent vector, and the respective context entities vector for the each of the one or more contextual units; and
concatenating, by an attention layer, the respective consolidated vector for each of the one or more contextual units into a single multi-dimensional context vector.

15. The method in claim 14, wherein one or more of:
the embedding layer comprises a pre-trained BERT model; or
the respective context token vector for each of the one or more contextual units further comprises one or more CLS tokens.

16. The method in claim 11, wherein:
determining the intent associated with the conversational input based on the context further comprises:
generating, by an embedding layer, a token vector for the conversational input; and
determining, by an intent classification layer, the intent based on the token vector and a single multi-dimensional context vector for the context.

17. The method in claim 16, wherein one or more of:
the embedding layer comprises a pre-trained BERT model;
the token vector for the conversational input further comprises one or more CLS tokens;
the intent classification layer comprises a first feedforward layer and a softmax layer; or
the single multi-dimensional context vector for the context is determined by:
generating, by the embedding layer, a respective context token vector for each of the one or more contextual units based on a respective context conversational input of the each of the one or more contextual units;
generating, by a second feedforward layer, a respective consolidated vector for each of the one or more contextual units based on: (a) the respective context token vector for the each of the one or more contextual units, (b) a respective context intent vector for a respective context intent associated with the respective context conversational input of the each of the one or more contextual units, and (c) a respective context entities vector for one or more respective context entities associated with the respective context conversational input of the each of the one or more contextual units; and
concatenating, by an attention layer, the respective consolidated vector for each of the one or more contextual units into the single multi-dimensional context vector.

18. The method in claim 11, wherein:
determining the one or more entities associated with the conversational input further comprises:
generating, by an embedding layer, a token vector for the conversational input;
concatenating the token vector, a single multi-dimensional context vector for the context, and an expected entities vector for the one or more expected entities into a consolidated entity vector; and
determining, by an entity recognizing layer, a respective entity tag for each of the one or more entities based on the consolidated entity vector.

19. The method in claim 18, wherein one or more of:
the single multi-dimensional context vector for the context is determined by:
generating, by the embedding layer, a respective context token vector for each of the one or more contextual units based on a respective context conversational input of the each of the one or more contextual units;
generating, by a third feedforward layer, a respective consolidated vector for each of the one or more contextual units based on: (a) the respective context token vector for the each of the one or more contextual units, (b) a respective context intent vector for a respective context intent associated with the respective context conversational input of the each of the one or more contextual units, and (c) a respective context entities vector for one or more respective context entities associated with the respective context conversational input of the each of the one or more contextual units; and
concatenating, by an attention layer, the respective consolidated vector for each of the one or more contextual units into the single multi-dimensional context vector;
the expected entities vector is encoded based on the one or more expected entities and predefined entity tags;
the embedding layer comprises a pre-trained BERT model;
the token vector for the conversational input further comprises one or more CLS tokens; or
the entity recognizing layer comprises a fourth feedforward layer and a softmax layer.

20. The method in claim 11, wherein:
the immediate prior one or more conversational inputs and the conversational input occur in a time session of a conversation.
